(19) United States
(12) Patent Application Publication
(10) Pub. No.: US 2013/0054349 A1
(43) Pub. Date: Feb. 28, 2013

(54) INTEGRATED AND COMPREHENSIVE ADVERTISING CAMPAIGN REMAP

(71) Applicant: Stuart Ogawa, Los Gatos, CA (US)

(72) Inventor: Stuart Ogawa, Los Gatos, CA (US)

(73) Assignee: Yahoo! Inc., Sunnyvale, CA (US)

(21) Appl. No.: 13/220,474

(22) Filed: Aug. 29, 2011

(51) Int. Cl. G06Q 30/00

(52) U.S. Cl. 705/14.43

(57) ABSTRACT

Techniques are provided for integrated and comprehensive advertising campaign management and optimization. Techniques are provided in which advertisers, including large-budget advertisers such as Chief Marketing Officers, can easily, efficiently and optimally define, manage and implement advertising budgets and campaigns, from high to granular levels, across a variety of online and offline channels. Techniques are provided in which, during implementation of a campaign, a set of recommended campaign resource allocation modifications are determined and provided and in which the advertiser can choose to implement some or all of the set of modifications, or modifications may be automatically implemented.

### BACKGROUND

Spending advertising dollars, from the advertiser executive perspective, can be a difficult and challenging problem. Advertiser and agency executives spend a large amount of time strategizing, budgeting, spending and measuring aggregate advertising dollar use and effectiveness. Chief Marketing Officers, for example, may have to rely upon a disparate mix of personal experience, in-house and third party data results and recommendations, and forecasting models, to name a few methods, in order to manage annual and multi-year advertising budgets and effectiveness. This process is not efficient and demonstrates advertiser inability to sufficiently obtain insights and to incrementally improve strategies based on data-driven insights. This problem is compounded by the huge amounts of marketing data from an increasing number of new direct and indirect online advertising channels, such as social networks and mobile channels, which increases the complexity and difficulty of obtaining meaningful insights.

Generally, managers of advertising campaigns, including large-budget, online and offline, multi-channel campaigns, lack, for example, optimal tools to harness information, inform them and allow them to efficiently and effectively accomplish their tasks, from high level tasks such as distribution and allocation of planned spend across various channels, to granular and detailed tasks such as particular advertising campaign allocations, spend, purchasing, adjustments, etc.

There is a need for improved techniques relating to advertising campaign management and optimization.

### SUMMARY

Some embodiments of the invention provide systems and methods for integrated and comprehensive advertising campaign management and optimization. Techniques are provided in which advertisers, including large-budget advertisers such as Chief Marketing Officers, can easily, efficiently and optimally define, manage, implement and refine advertising budgets and campaigns, from high to granular levels, across a variety of online and offline channels. Such channels can include Web, mobile, social networking, etc., as well as traditional advertising channels such as TV, radio, etc. Techniques are provided, for example, in which advertisers, with a single click or selection, can cause formulation and implementation of a customized, optimized and comprehensive online and offline advertising campaign.

In some embodiments, techniques are provided in which advertiser target customer profile templates, publisher audience segment templates, and matching templates are generated, modified, stored, selected and utilized to efficiently optimize advertising campaigns, including inventory matching, leading to increasing campaign effectiveness, reduced and more effectively spent campaign management time, and increased ROI.

In some embodiments, techniques are provided that include allowing advertisers or publishers to simulate implementation of an advertising campaign, which can include selecting and utilizing target customer, audience segment, and matching profiles. Tools are provided for viewing outcomes and results, which can aid and inform advertising campaign planning and purchasing.

In some embodiments, techniques are provided in which advertisers, with a single click or selection, can select, for implementation, all of or a portion of an advertising campaign.

In some embodiments, a visualization tool is provided to advertisers, through which visualization displays can be caused to be generated, which displays provide visual analytics that can be used in assessing aspects of performance of an advertising campaign.

In some embodiments, techniques are provided in which, during implementation of a campaign, a set of recommended campaign resource allocation modifications are determined and provided and in which the advertiser can choose to implement some or all of the set of modifications.

### BRIEF DESCRIPTION OF THE DRAWINGS

FIG. 1 is a distributed computer system according to one embodiment of the invention;

FIG. 2 is a flow diagram illustrating a method according to one embodiment of the invention;

FIG. 3 is a flow diagram illustrating a method according to one embodiment of the invention;

FIG. 4 is a flow diagram illustrating a method according to one embodiment of the invention;

FIG. 5 is a flow diagram illustrating a method according to one embodiment of the invention;

FIG. 6 is a block diagram illustrating one embodiment of the invention;

FIG. 7 is a block diagram illustrating one embodiment of the invention;

FIG. 8 is a flow diagram illustrating a method according to one embodiment of the invention;

FIG. 9 is a flow diagram illustrating a method according to one embodiment of the invention;

FIG. 10 is a flow diagram illustrating a method according to one embodiment of the invention;

FIG. 11 is a block diagram illustrating one embodiment of the invention; and

FIG. 12 is a block diagram illustrating one embodiment of the invention;

FIG. 13 is a flow diagram illustrating a method according to one embodiment of the invention;

FIG. 14 is a flow diagram illustrating a method according to one embodiment of the invention;

FIG. 15 is a flow diagram illustrating a method according to one embodiment of the invention;

FIG. 16 is a flow diagram illustrating a method according to one embodiment of the invention;

FIG. 17 is a block diagram illustrating one embodiment of the invention;

FIG. 18 is a block diagram illustrating one embodiment of the invention;

FIG. 19 is a block diagram illustrating one embodiment of the invention;

FIG. 20 is a flow diagram illustrating a method according to one embodiment of the invention;

FIG. 21 is a block diagram illustrating a method according to one embodiment of the invention; and

FIG. 22 is a block diagram illustrating one embodiment of the invention.

While the invention is described with reference to the above drawings, the drawings are intended to be illustrative, and the invention contemplates other embodiments within the spirit of the invention.

### DETAILED DESCRIPTION

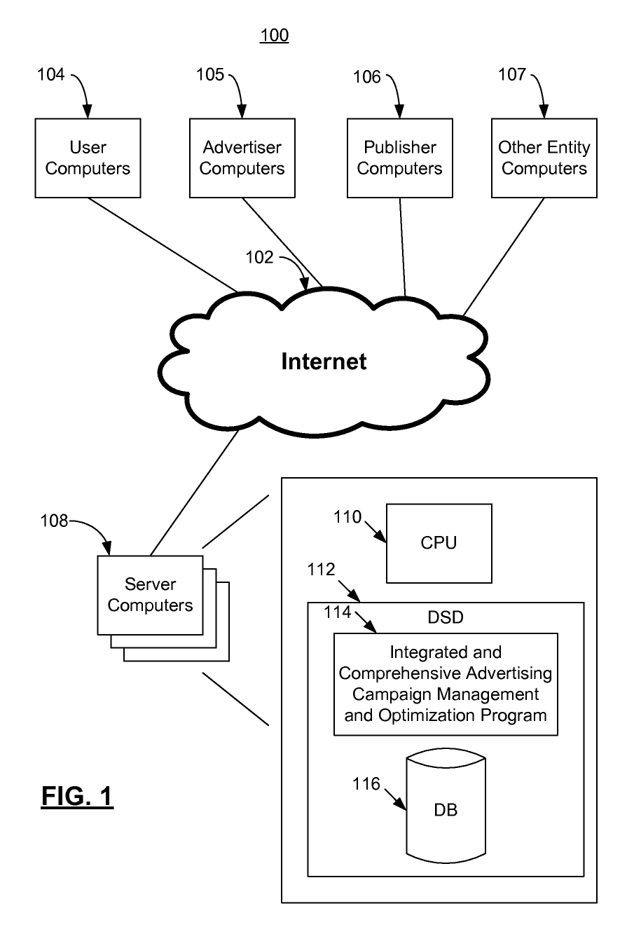

FIG. 1 is a distributed computer system 100 according to one embodiment of the invention. Although many configurations are possible, the system 100 as depicted includes user computers 104, advertiser computers 105, publisher computers 106, other entity computers 107, and server computers 108, all coupled or able to be coupled to the Internet 102. Although the Internet 102 is depicted, the invention contemplates other embodiments in which the Internet is not included, as well as embodiments in which other networks are included in addition to the Internet, including one more wireless networks, WANs, LANs, telephone, cell phone, or other data networks, etc. The invention further contemplates embodiments in which user computers or other computers may be or include wireless, portable, or handheld devices such as cell phones, PDAs, etc.

Each of the one or more computers 104-108 may be distributed, and can include various hardware, software, applications, algorithms, programs and tools. Depicted computers may also include a hard drive, monitor, keyboard, pointing or selecting device, etc. The computers may operate using an operating system such as Windows by Microsoft, etc. Each computer may include a central processing unit (CPU), data storage device, and various amounts of memory including RAM and ROM. Depicted computers may also include various programming, applications, algorithms and software to enable searching, search results, and advertising, such as graphical or banner advertising as well as keyword searching and advertising in a sponsored search context. Many types of advertisements are contemplated, including textual advertisements, rich advertisements, video advertisements, etc.

As depicted, each of the server computers 108 includes one or more CPUs 110 and a data storage device 112. The data storage device 112 includes a database 116 and Integrated and Comprehensive Advertising Campaign Management Program 114.

The Program 114 is intended to broadly include all programming, applications, algorithms, software and other and tools necessary to implement or facilitate methods and systems according to embodiments of the invention. The elements of the Program 114 may exist on a single server computer or be distributed among multiple computers or devices.

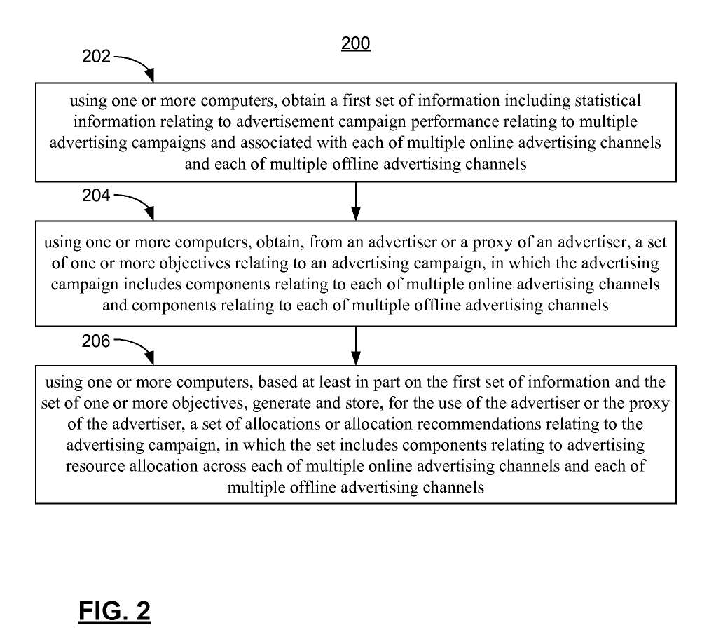

FIG. 2 is a flow diagram illustrating a method 200 according to one embodiment of the invention. At step 202, using one or more computers, a first set of information is obtained, including statistical information relating to advertisement campaign performance relating to multiple advertising campaigns and associated with each of multiple online advertising channels and each of multiple offline advertising channels.

At step 204, using one or more computers, a set of one or more objectives is obtained, from an advertiser or a proxy of an advertiser, relating to an advertising campaign. The advertising campaign includes components relating to each of multiple online advertising channels and components relating to each of multiple offline advertising channels.

At step 206, using one or more computers, based at least in part on the first set of information and the set of one or more objectives, a set of allocations or allocation recommendations relating to the advertising campaign is generated and stored, for the use of the advertiser or the proxy of the advertiser. The set includes components relating to advertising resource allocation across each of multiple online advertising channels and each of multiple offline advertising channels.

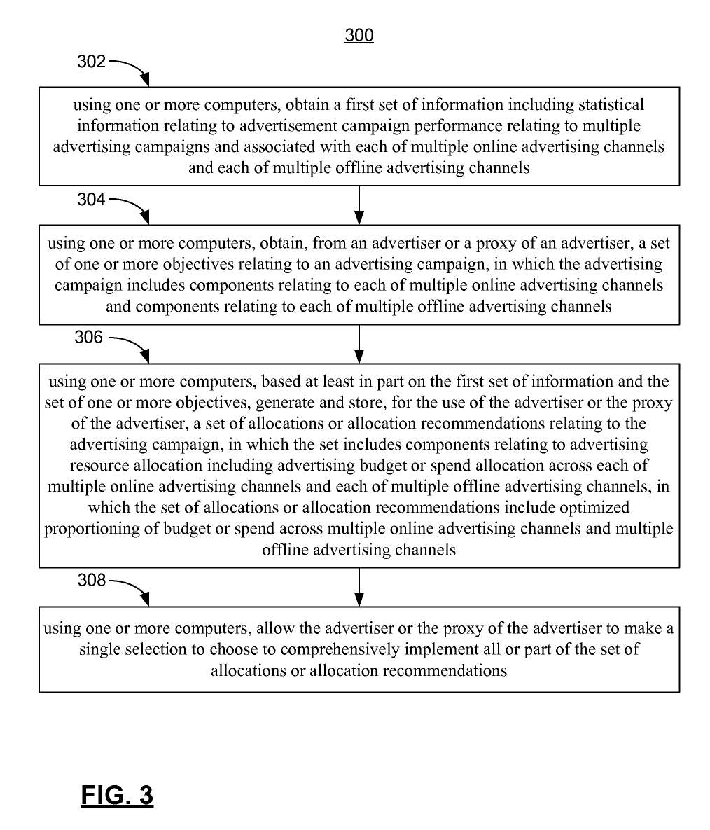

FIG. 3 is a flow diagram illustrating a method 300 according to one embodiment of the invention. At step 302, using one or more computers, a first set of information is obtained, including statistical information relating to advertisement campaign performance relating to multiple advertising campaigns and associated with each of multiple online advertising channels and each of multiple offline advertising channels.

At step 304, using one or more computers, a set of one or more objectives is obtained, from an advertiser or a proxy of an advertiser, relating to an advertising campaign. The advertising campaign includes components relating to each of multiple online advertising channels and components relating to each of multiple offline advertising channels.

At step 306, using one or more computers, based at least in part on the first set of information and the set of one or more objectives, a set of allocations or allocation recommendations are generated and stored, for the use of the advertiser or the proxy of the advertiser, relating to the advertising campaign. The set includes components relating to advertising resource allocation including advertising budget or spend allocation across each of multiple online advertising channels and each of multiple offline advertising channels. Furthermore, the set of allocations or allocation recommendations include optimized proportioning of budget or spend across multiple online advertising channels and multiple offline advertising channels.

At step 308, using one or more computers, the advertiser or the proxy of the advertiser is allowed or provided with an option to make a single selection to choose to comprehensively implement all or part of the set of allocations or allocation recommendations.

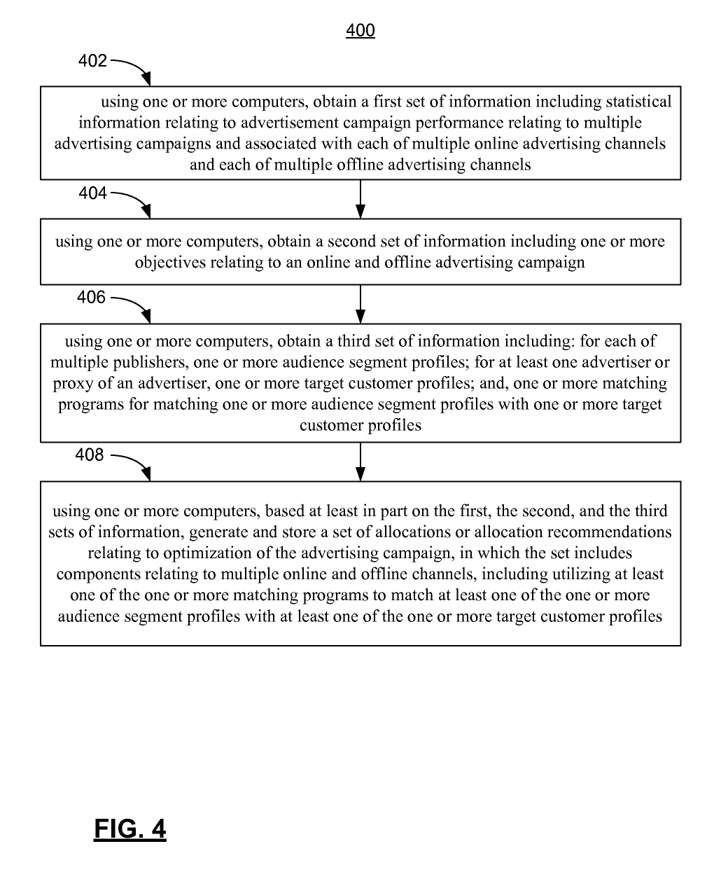

FIG. 4 is a flow diagram illustrating a method 400 according to one embodiment of the invention. At step 402, using one or more computers, a first set of information is obtained, including statistical information relating to advertisement campaign performance relating to multiple advertising campaigns and associated with each of multiple online advertising channels and each of multiple offline advertising channels.

At step 404, using one or more computers, a second set of information is obtained, including one or more objectives relating to an online and offline advertising campaign.

At step 406, using one or more computers, a third set of information is obtained, including: for each of multiple publishers, one or more audience segment profiles; for at least one advertiser or proxy of an advertiser, one or more target customer profiles; and, one or more matching programs for matching one or more audience segment profiles with one or more target customer profiles.

At step 408, using one or more computers, based at least in part on the first, the second, and the third sets of information, a set of allocations or allocation recommendations are generated and stored, relating to optimization of the advertising campaign. The set includes components relating to multiple online and offline channels, including utilizing at least one of the one or more matching programs to match at least one of the one or more audience segment profiles with at least one of the one or more target customer profiles.

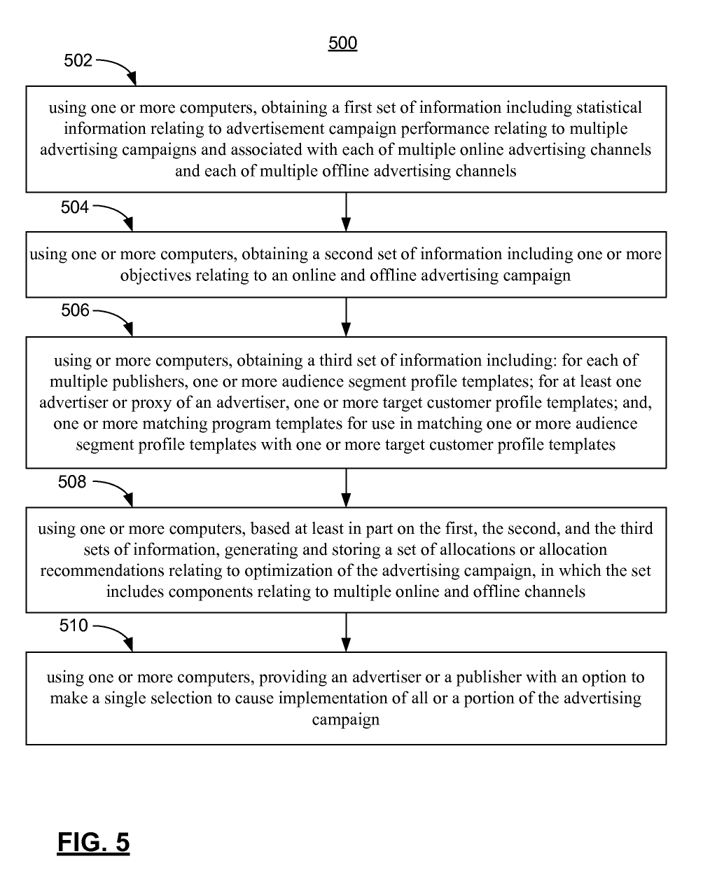

FIG. 5 is a flow diagram illustrating a method 500 according to one embodiment of the invention. At step 502, using one or more computers, a first set of information is obtained, including statistical information relating to advertisement campaign performance relating to multiple advertising campaigns and associated with each of multiple online advertising channels and each of multiple offline advertising channels.

At step 504, using one or more computers, a second set of information is obtained, including one or more objectives relating to an online and offline advertising campaign.

At step 506, using one or more computers, a third set of information is obtained, including: for each of multiple publishers, one or more audience segment profile templates; for at least one advertiser or proxy of an advertiser, one or more target customer profile templates; and, one or more matching program templates for use in matching one or more audience segment profile templates with one or more target customer profile templates.

At step 508, using one or more computers, based at least in part on the first, the second, and the third sets of information, a set of allocations or allocation recommendations is generated and stored, relating to optimization of the advertising campaign, in which the set includes components relating to multiple online and offline channels.

At step 510, using one or more computers, an advertiser or a publisher is provided with an option to make a single selection to cause implementation of all or a portion of the advertising campaign.

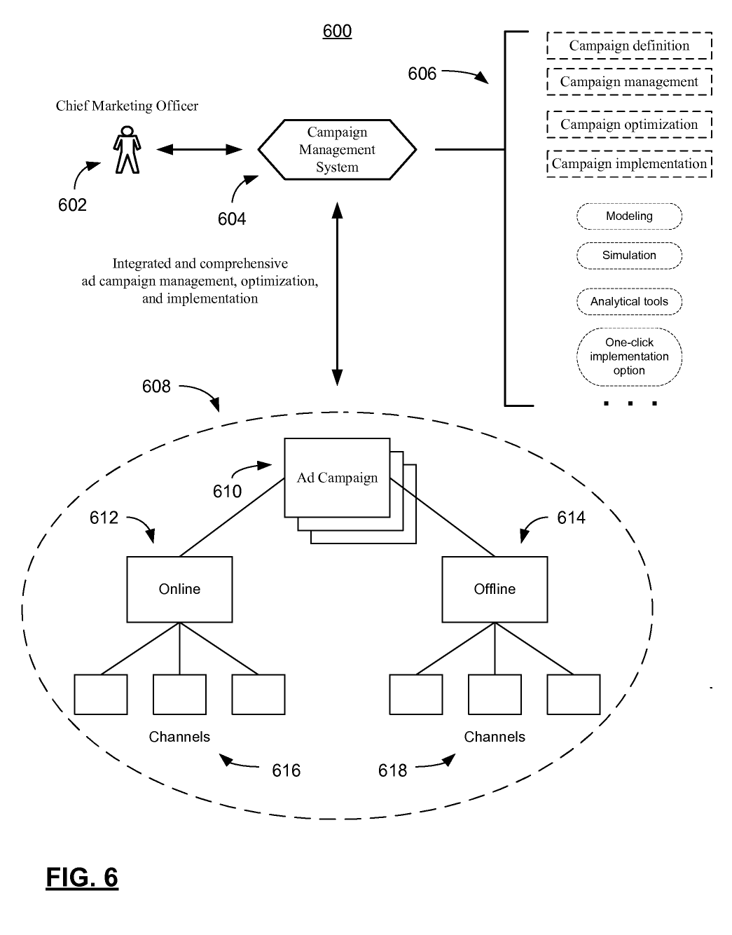

FIG. 6 is a block diagram 600 illustrating one embodiment of the invention. As depicted, as advertiser, which may be a large budget advertiser such as a Chief Marketing Officer 602 has access to a Campaign Management System 604 according to one embodiment of the invention.

While embodiments of the invention are often described with reference to a Chief Marketing Officer, it is to be understood that the invention contemplates advertisers broadly and generally, including not only Chief Marketing Officers, but also any of various advertisers, agents of advertisers, proxies of advertisers, etc., which can include marketers, staff, employees, associated entities, etc.

The Campaign Management System 604 may include many different aspects, functions, modules, etc. As depicted, these may include components 606 relating to campaign definition, campaign management, campaign optimization, campaign implementation, modeling, simulation, analytical tools, options such as a one-click or one-selection implementation option, etc.

The Campaign Management System 604 may be used by the Chief Marketing Officer 602, for example, in connection with one or more advertising campaigns, such as the depicted advertising campaign 608, which includes an online component 612 with multiple channel components 616 as well as an offline component 614 with multiple channel components 618. It is to be noted that the advertising campaign 608 can contain multiple other campaigns or subcampaigns, such as hierarchically or family-related campaigns. Additionally, various particular components of the advertising campaign 608, including the online component 612, offline component 614, and various channel components 618, can also include hierarchically or family-related components or sub-components.

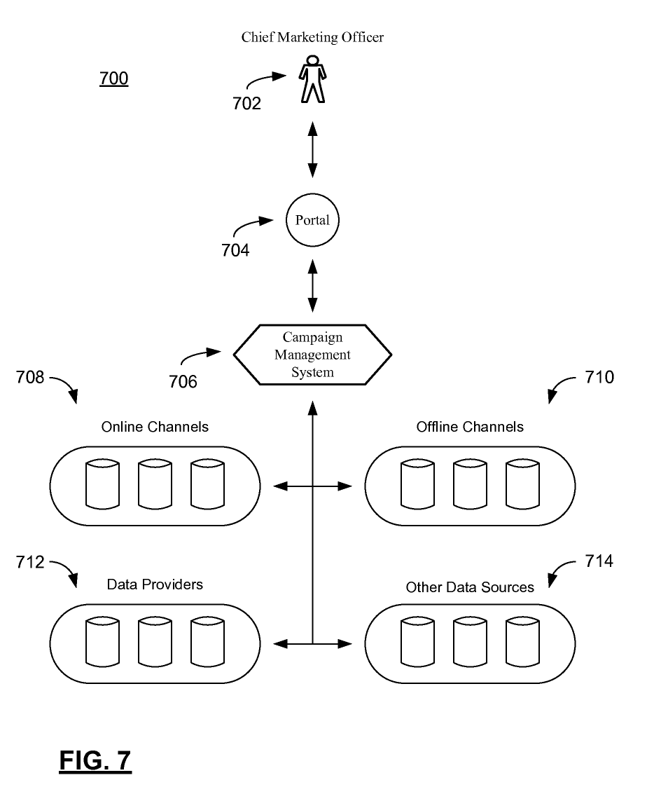

FIG. 7 is a block diagram 700 illustrating one embodiment of the invention. As depicted, a Chief Marketing Officer 702 obtains access via a portal 704, such as a Web-based portal, to a Campaign Management System 706 according to one embodiment of the invention.

The Campaign Management System 706 accesses information from a variety of distributed data sources and databases, and may also be in two way communication with such data sources. These can include, for example, information from various online channels 708, offline channels 710, data providers 712, and various other sources 714. Information from the data sources is used in carrying out various Campaign Management System 706 functions.

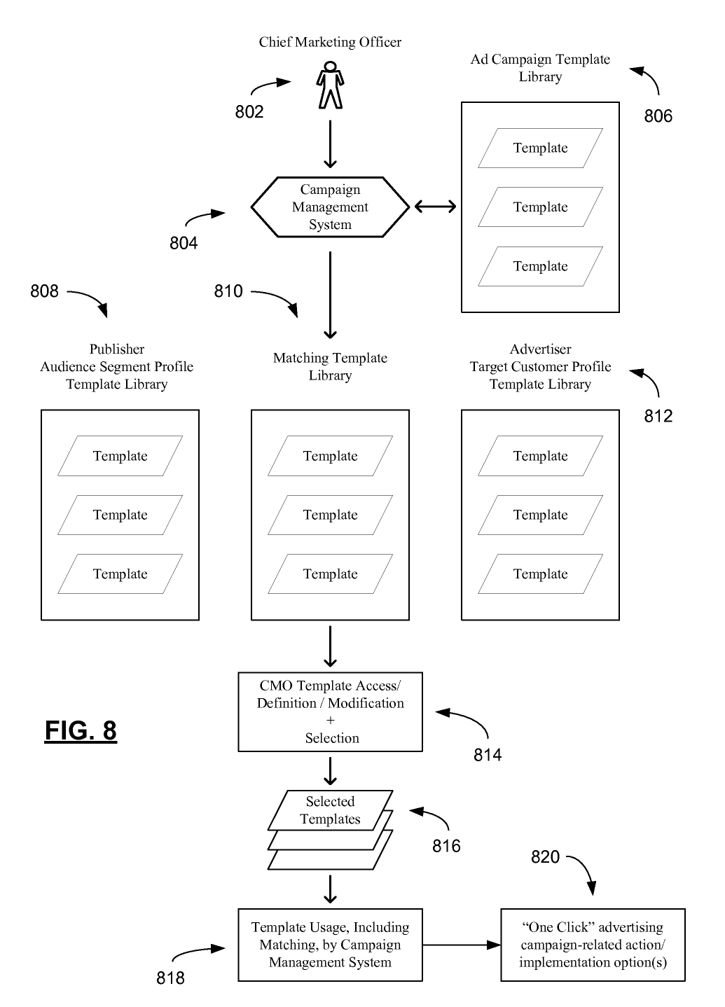

FIG. 8 is a flow diagram illustrating a method 800 according to one embodiment of the invention, including use of templates. In some embodiments, templates provide a convenient, flexible, efficient tool for helping achieving customized, precise, high-definition and granular functionality for use of an advertiser 802, such as a Chief Marketing Officer, for example. This can include, for example, matching of advertiser customer profiles with publisher audience segment profiles. A customer, as the term is used herein, broadly includes any targeted user, whether or not a purchaser or intended purchaser. Generally, templates can include data structures as well as the information stored within. Templates can include additional features such as models, applications, programs, etc. Use the term is used herein, a template can include data structures with or without stored, identified, particular or customized information. Templates can contain information useful in various campaign management, optimization and implementation functionality. A very simple example of a template could include a form with various pre-defined records or fields for storing particular advertiser-associated information, which may be accomplished or facilitated by or with use of a Campaign Management System 804. However, much more sophisticated templates are contemplated by embodiments of the invention.

Also depicted are an advertising campaign template library 806, a library 808 of publisher audience segment profile templates, a library 812 of advertiser targeted customer (or other targeted user) profile templates, and a library 810 of matching templates. As represented by step 814, the advertiser 802 selects (or defines or customizes and explicitly or implicitly selects) templates 816 to be utilized, which can include one or more templates from, or derived from, each of the libraries 808, 810, 812, and can also include other selected templates, such as one or more advertising campaign templates, for example.

Step 818 represents use of templates, such as selected templates, in various ways with or by the Campaign Management System 804. This can include, for example, matching audience segment profile templates with targeted customer profile templates using matching templates, to help optimally inform advertising planning, purchasing, etc.

Step 820 represents “One Click” advertising campaign-related action/implementation option(s), which may be made available to the advertiser in some embodiments of the invention. As also described elsewhere herein, in some embodiments, advertisers or publishers are provided with options to take action related to one or more advertising campaigns, such as to implement all or a portion or aspect of a campaign, such as by a single click or selection. For example, the advertiser may be provided with one or more suggested or recommended campaign implementation options, which may include, for example, a comprehensive multichannel online and offline advertising campaign, which may include bidding or purchasing, or which may be viewed or modified by the advertiser before being caused to be implemented. In various embodiments, such a campaign or portion of a campaign may be implemented immediately or over time, and may or may not be subject to adjustment or modification over time. In some embodiments, such options may be related to or based on one or more simulated advertising campaigns or campaign portions. Furthermore, in some embodiments, the advertiser may use various analytical and visualization tools, including graphs, charts, summaries, analytical results, etc., and a one-click action or implementation option may be provided in connection therewith or otherwise.

In some embodiments of the invention, systems are provided that portfolio manage all online and offline advertising information, from the advertiser and agency business perspective, and that use a collection of methods including, but not limited to, simulations, predictive and causal forecast modeling, actionable insight software engines, recommendation engines, data mining, visual analytics, text analytics, and data warehouses, for example, to optimize overall business advertising goals, objectives, and models.

Some embodiments recognize that previous systems and methods are unable to provide or sufficiently provide meaningful insights and propose or implement actions for an advertising portfolio (from an advertiser perspective) consisting of both traditional offline advertising methods and online advertising methods. For example, previous solutions are typically fragmented, labor intensive and semi-automated processing intensive, and do not provide or sufficiently provide timely insights and actionable information.

Some embodiments of the invention, for example, enable advertisers to increase topline revenue by spending substantially more time understanding advertising insights and optimizing actions, instead of spending too much time using manual and semi-automated processes to turn data into inconsistent information with little to no insights.

Some embodiments provide systems and collections of methods using software, databases, and modern communication methods in providing advertisers with a holistic, data driven advertising picture and that operationalizes advertising strategies, insights, recommendations, incremental improvement changes, dollar spend recommendations, portfolio advertising management, and reporting, among other things. Systems are provided that aggregate data from a variety of sources and use methods to translate the data into meaningful and insightful business information, to present the information along with recommendations, to facilitate advertising purchases, and to provide holistic and insightful active advertising management, among other things. The aggregate of these methods can collectively apply to both traditional offline advertising methods and to the latest online advertising methods.

Some embodiments provide systems and methods for the advertising sector that can be viewed as is conceptually incorporating approaches that, while novel and non-obvious over, can be analogized in some ways with computerized automated investment trading systems, such as Goldman Sachs' trading systems, and global travel ticketing systems, such as Sabre. Automated trading systems, for example, analytically sift through mountains of data and take manual, semi-automated, and automated trade actions. Systems such as the Sabre travel system tie together the global inventory of airlines, hotels, and rental cars.

Some embodiments can further include techniques that, while novel and non-obvious, can be analogized in some ways with methods from other industries, such as Amazon's book recommendation analytic engine and Netflix's Cinematic movie recommendation engine, applying combined techniques, among other things, to the advertising buyer space and providing a world class system for global advertisers.

Some embodiments include the following, for example. An advertiser selects an industry advertising campaign template, modifies an existing campaign template or creates new campaign template. Using various provided applications, graphical user interfaces, etc., the advertiser may input variables, such as advertising goals, keywords, KPIs, market segments, budgets, historical data, results, etc., into, and adding to, the template. The advertiser may run advertising simulations using statistics, such as Monte Carlo technique-based simulations, for example. The advertiser may review simulation results, including channel recommendations, KPI simulation results, proposed changes, proposed advertising optimization recommendations, etc. The advertiser may review real-time advertising inventory availability and cost, and may compare them to simulations. Furthermore, the advertiser may make a single selection, such as, for a particular example, selecting “One Click Campaign” to purchase advertising in online and traditional channels in one step.

Furthermore, some embodiments provide a variety of other functionality or features. For example, in some embodiments, an advertiser may monitor and manage a portfolio of overall or segment campaigns. In some embodiments, an advertiser may enable application recommendation analytics to provide insights, or may enable automated application analytic campaign changes and optimizations in order to attain KPIs and goals, for example. In some embodiments, an advertiser may enable application of analytic competitive recommendations, such as, for a particular example, “businesses targeting this segment and audience also selected X online property and Y traditional channel”, etc. Furthermore, in some embodiments, an advertiser can run visual analytics such as real time heat maps to identify and track successful campaigns and campaigns where business actions need changes and corrections, for example.

As described above, embodiments of the invention contemplate use with and for advertising campaigns including components relating to various online, including digital, channels as well as various offline channels. Online advertising channels can include, for example, various types of Web portal properties such as news, sports, etc., virtual reality and virtual worlds, gaming, search engines such as Google, Baidu, etc., social networks such as Linkedin, Twitter, Facebook etc., mobile channels such as provided by Admob, Apple, Kindle including ebooks, Amazon, etc. Of course, there are many other online channels that are contemplated by embodiments of the invention.

Embodiments of the invention also contemplate a variety of offline channels. These can include, for example, traditional channels such as physical advertising, television, cable, satellite, radio, print such as newspaper, magazine, consortium, etc. Offline channels can include, for example, sports-related and other event-related or activity-related advertising, such as endorsement, outdoor proximity advertising at sports arenas, sports events, etc. Of course, there are many other online channels that are contemplated by embodiments of the invention.

Some embodiments of the invention include techniques that address advertiser (including agency) interests, and can include matching advertiser campaigns to target audiences, for example.

Some embodiments of the invention provide techniques, methods and systems that enable an advertiser to self-serve, control, compute and match an advertiser's ideal, high definition customer profile to a publisher's high definition audience target profile. For example, techniques are provided that enable advertisers to define and create N number of high definition target customer profile. Techniques are further provided that enable advertisers to select and or modify a publisher's high definition audience segment profile from a library of N audience segment profiles. Techniques are also provided that enable the advertiser to select and or modify a publisher's matching programs, from a library of publisher's matching programs, which can include, for example, analytics, in order to compute match the advertiser's high definition target customer profile to the publishers high definition target audience profile (or profile template). In some embodiments, this results in an optimized or near-perfect advertiser ideal customer to audience match. This can increase the advertiser's achievement of goals, such as revenue or brand engagement. For example, provided techniques can lead as to higher performance measures such as higher conversion rates, increases advertising campaign ROI, increases advertiser end-to-end advertising campaign control, or increased brand engagement. Furthermore, provided techniques can reduce advertising campaign expenditures by reducing targeting of incorrect or non-optimized audiences.

Some embodiments of the invention recognize that a Chief Marketing Officer ideal goal can be to create the perfect advertising campaign by defining an ideal customer profile and surgically targeting only audiences that match ideal customers. This perfect, albeit utopian, state of alignment increases advertiser's revenue, increases advertising campaign ROI, and reduces advertising campaign expenses on campaigns targeting the incorrect audiences, as the alignment gap decreases.

Some embodiments further include a recognition that, despite the technology that exists today, publishers and value-add service providers in the online and offline advertising ecosystem have not materially or sufficiently decreased the aforementioned alignment gap and have not materially or sufficiently moved toward the utopia alignment state for Chief Marketing Officers. Amplifying the misalignment and further increasing the alignment complexity is the increased amount of data, the increased number of new media channels (mobile, social networks, etc.), and the lack of integrated systems and methods to compute and present actionable advertising campaign options directly in the hands of Chief Marketing Officers. Some embodiments of the invention provide techniques that help close the alignment gap between advertisers ideal target customers and online/offline publishers' target audiences.

Some embodiments of the invention provide techniques that provide advertisers with a portal into all online and offline advertising channels and inventory. This can allow advertisers to avoid inefficient spending of time using previous online methods and calling traditional advertisers to conduct an overarching global campaign, and can allow advertisers to more quickly launch campaigns.

Some embodiments include providing advertisers with pricing information, such as pricing of advertising inventory. Such techniques can allow easier and faster pricing of an entire campaign, regardless of the number of online and offline advertising channels, to support an overarching campaign, decreasing internal time spent per campaign.

Some embodiments provide advertisers with the ability to create and templatize global advertising campaigns. This can allow easier launching of N number of campaigns per year without people spending time recreating and re-launching online and offline campaigns, reducing labor costs associated with online and offline campaigns.

Furthermore, some embodiments include use of templates that may be termed SuperAdCampaign (SAC) templates, which can be relational advertising campaign templates. In some embodiments, SACs can be aggregated, structured, and organized to facilitate multi-faceted or multi-tiered hierarchies, such as parent/children campaign structures, for example, that can drive end-to-end macro-to-micro advertising campaigns. For example, a SAC campaign template can have a global parent campaign advertising campaign message and children advertising campaign templates tailored to local regional needs and requirements, yet children campaigns are related to the parent and reinforce and easily manage the overall parent advertising campaign template. Algorithms and analytics can be imbedded into the SAC template and applied to one or more specific meta-characteristics using N number of variables, such as time, in order to reposition advertising campaigns in real time and to account for changes, such as advertisement effectiveness decay, as one example. Algorithms and analytics can be applied to the SAC template using N number of variables, such as real-time geo meta-data or causal forecasting, to reposition advertising campaigns, for example.

Some embodiments provide advertisers with the ability to create highly defined targeted customer templates. This can allow easier creation and templatization of a 360 degree view of target customers in high definition. Such techniques can use, for example, N number of variables, algorithms, user defined characteristics, keywords, etc., to characterize or profile ideal or targeted customers.

Some embodiments of the invention provide for optimal and granular use of user, customer, and audience information while guarding privacy.

Some embodiments provide advertisers with the ability to integrate input variables from their own customer database into an ideal or targeted customer or customer segment template. Furthermore, some embodiments provide advertisers with the ability to incorporate input variables from their advertising agencies, third party data providers and marketeers (e.g. Nielsen), etc. into their customer template. Furthermore, some embodiments provide advertisers with the ability to incorporate algorithms and analytics, such as machine learning, into their customer segment template. These various techniques can sharpen and focus ideal customer targeting.

Some embodiments provide advertisers with the ability to look at a publisher's library of audience segments to better view, control, and launch target audiences. This can provide advertisers with a variety of target audience campaign options that they might not have thought about before, and, generally, the more target audience segment options, the better the associated campaign results.

Some embodiments provide advertisers with one or more search engines, such as a search engine associated with template libraries, including audience segment profile templates. Such search engines can be used, for example, in finding audience segments in the publisher's audience segment library. Such techniques can provide the advertiser with the ability to search for and quickly identify the most relevant target audience segment options, for example, among other things.

Some embodiments enable advertisers to create and modify publisher audience segment profile templates, such as to order to sharpen target audience segments. This can enable an advertiser to further tune and align the advertiser's target customer profile or profile template to the publisher's audience segment profile or profile templates, for example.

Some embodiments enable advertisers to create, view, and modify publisher matching programs from a library of publisher matching programs. This can enable the advertiser to create and modify publishers' matching programs to further optimize the alignment between the advertiser's target customer profile template and the publisher's audience segment profile template, for example.

Some embodiments provide advertisers with the ability to incorporate or modify algorithms and analytics in publisher matching templates. This can, for example, include or allow use of machine learning to automatically sharpen and focus matching of target customer profile templates with audience segment profile templates, giving more and better control to the advertiser, for example.

Some embodiments enable a publisher to scalably create and easily launch N number of high definition audience segment profile templates. This can result in increased publisher revenue by enabling advertisers to launch N number of campaigns per year globally while minimizing labor costs.

Some embodiments enable a publisher to create a scalable ecosystem that connects publishers, advertisers, such as Global 2000 advertisers, and other ecosystem online and offline value-added services and providers into a single platform. This can increase publisher revenue by creating a system that allows an advertiser to see, view, and book a global campaign anywhere, anytime. Furthermore, in some embodiments, service campaign analytics can be sold to advertisers.

Some embodiments enable a publisher to connect all of the online and offline advertisers to make it easier for advertisers to one-stop purchase global campaigns. This can increase publisher revenue by making it easier and faster for the advertiser to spend every advertising campaign dollar in their budget. The publisher may participate and monetize a part of every dollar spent by Global 2000 advertising campaigns, for example.

Some embodiments enable publishers to create sophisticated, analytics-driven options for advertisers. As a particular example, a note or recommendation may be provided, such as “people who created this campaign also purchased this audience segment”. Such techniques can increase publisher revenue via self-serve and or analytic driven offers or next-best offers, for instance.

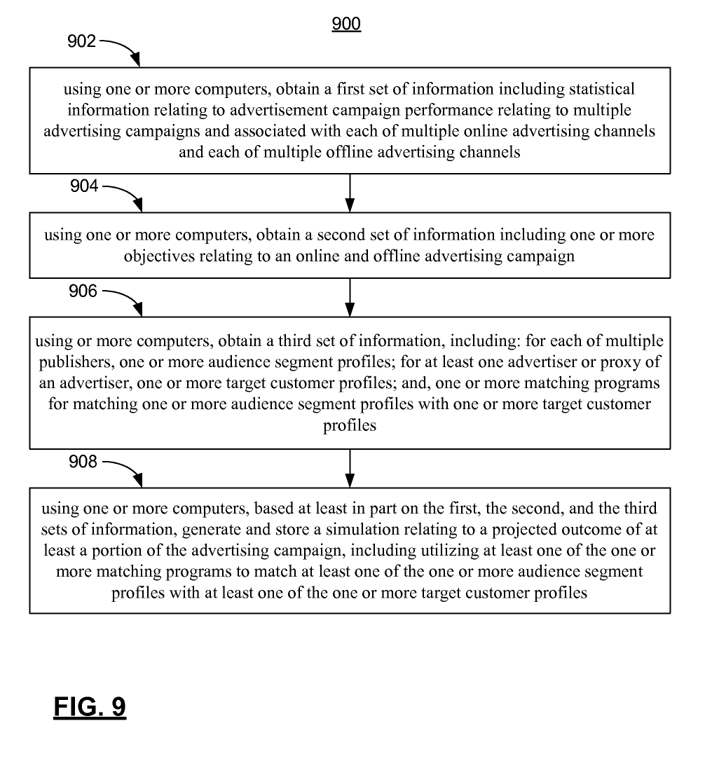

FIG. 9 is a flow diagram illustrating a method 900 according to one embodiment of the invention. At step 902, using one or more computers, a first set of information is obtained, including statistical information relating to advertisement campaign performance relating to multiple advertising campaigns and associated with each of multiple online advertising channels and each of multiple offline advertising channels.

At step 904, using one or more computers, a second set of information is obtained, including one or more objectives relating to an online and offline advertising campaign.

At step 906, using or more computers, a third set of information is obtained, including: for each of multiple publishers, one or more audience segment profiles; for at least one advertiser or proxy of an advertiser, one or more target customer profiles; and, one or more matching programs for matching one or more audience segment profiles with one or more target customer profiles.

At step 908, using one or more computers, based at least in part on the first, the second, and the third sets of information, a simulation is generated and stored, relating to a projected outcome of at least a portion of the advertising campaign, including utilizing at least one of the one or more matching programs to match at least one of the one or more audience segment profiles with at least one of the one or more target customer profiles.

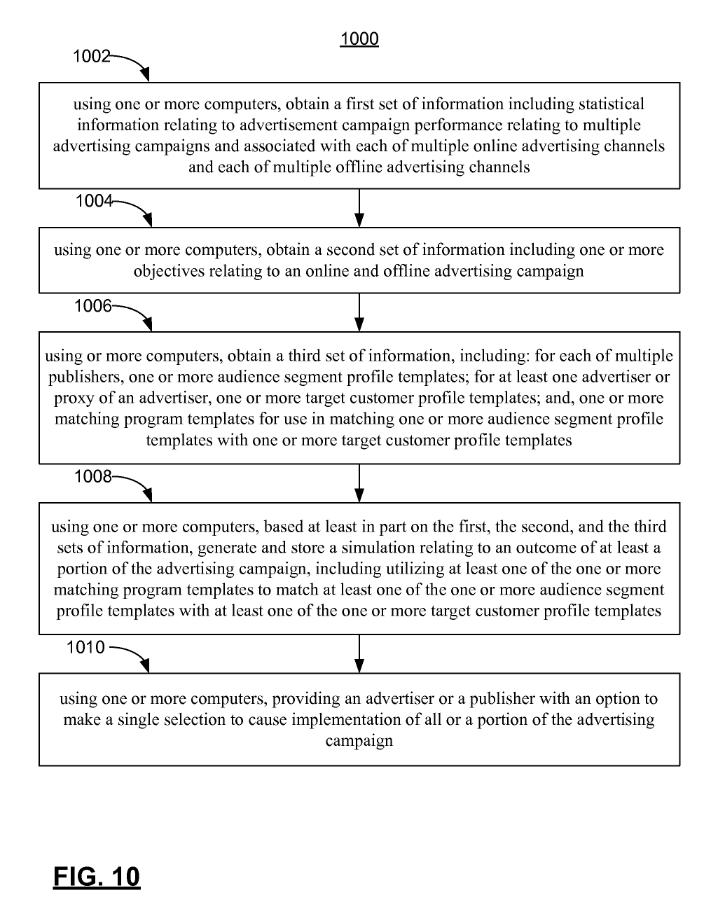

FIG. 10 is a flow diagram illustrating a method 1000 according to one embodiment of the invention. Steps 1002 and 1004 are similar to step 902 and 904 as depicted in FIG. 9.

At step 1006, using or more computers, a third set of information is obtained, including: for each of multiple publishers, one or more audience segment profile templates; for at least one advertiser or proxy of an advertiser, one or more target customer profile templates; and, one or more matching program templates for use in matching one or more audience segment profile templates with one or more target customer profile templates.

At step 1008, using one or more computers, based at least in part on the first, the second, and the third sets of information, a simulation is generated and stored, relating to an outcome of at least a portion of the advertising campaign, including utilizing at least one of the one or more matching program templates to match at least one of the one or more audience segment profile templates with at least one of the one or more target customer profile templates.

At step 1010, using one or more computers, an advertiser or a publisher is provided with an option to make a single selection to cause implementation of all or a portion of the advertising campaign.

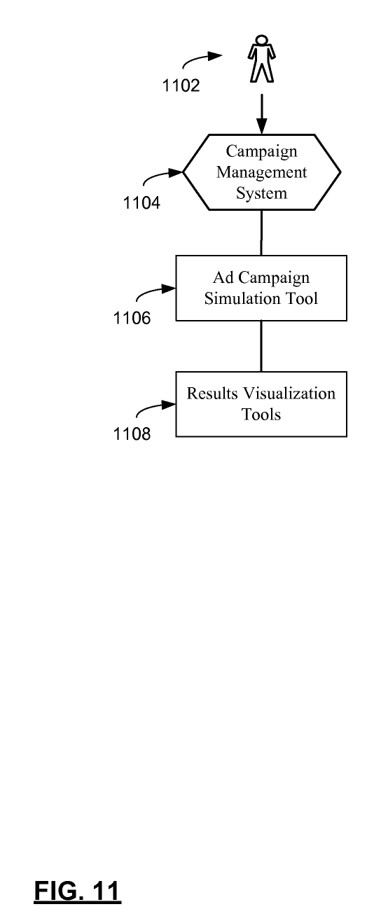

FIG. 11 is a block diagram 1100 illustrating one embodiment of the invention. An advertiser or publisher 1102 is depicted, utilizing an advertising campaign management system 1104 according to an embodiment of the invention.

Block 1106 represents an advertising campaign simulation tool according to an embodiment of the invention, which may be part of the advertising campaign management system 1104.

Block 1108 represents a set of results visualization tools. The tools can be used by the advertiser or publisher, or one or more other parties, to construct, view and analyze hypothetical results or outcomes of simulated advertising campaigns, or portions thereof, or to visualize other information useful in assessing one or more advertising campaigns or portions thereof. Of course, many additional elements and components may also be included.

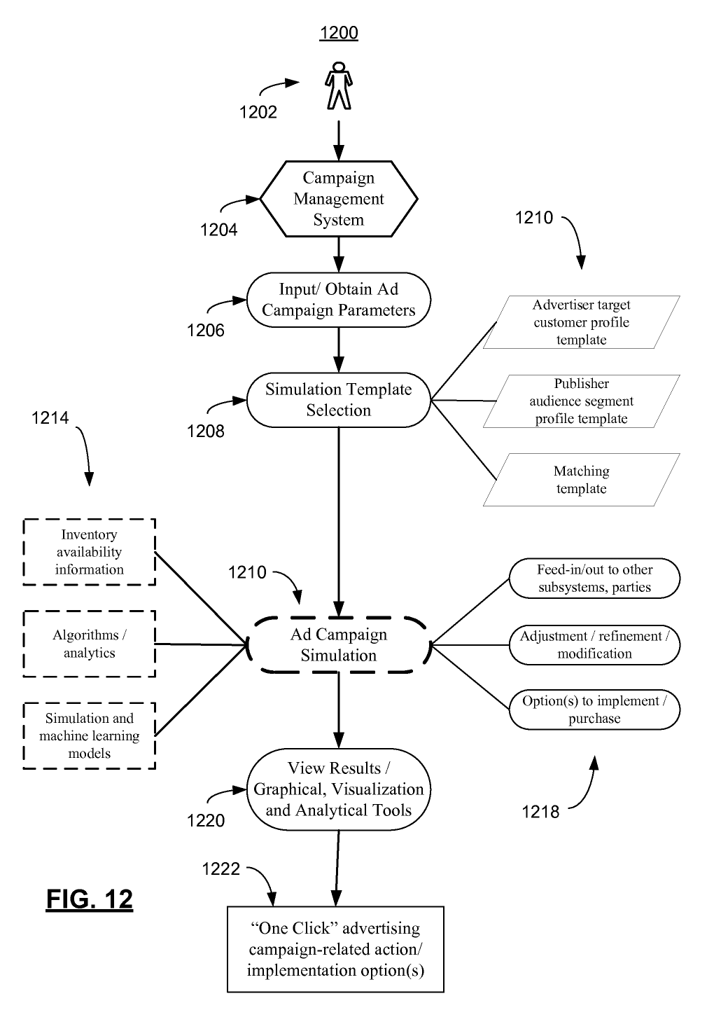

FIG. 12 is a block diagram 1200 illustrating one embodiment of the invention. An advertiser or publisher 1202 is depicted, utilizing an advertising campaign management system 1204 according to an embodiment of the invention.

Block 1206 represents input or obtaining of advertising campaign or associated parameters, which can include campaign objective information, among other things.

Block 1208 represents selection of templates to be used in a simulation, such as by the advertiser or publisher 1202. A set of selected templates 1210 can include an advertiser target customer profile template, a publisher audience segment profile template, and a matching template. In some embodiments, the templates are specifically or exclusively designated or utilized simulation templates, while in other embodiments, they are not.

Block 1210 represents advertising campaign simulation, which can include running or implementation of one or more advertising campaign simulations. Various tools, software, algorithms, information, etc., can be used in this regard, including, as represented by blocks 1214, among other things, actual, estimated or projected inventory availability information, algorithms and analytics, and simulation and machine learning models.

As represented by blocks 1218, results or information from simulations can be used as a feed-in or feed-out to other advertising campaign management subsystems, other systems entirely, or other entities or parties. Furthermore, adjustment, refinement and modification functionality or features may be utilized or provided. Still further, functionality may be provided to allow an advertiser to make purchases or implementations relating to advertising campaigns, such as through or in connection with simulations.

Block 1220 represents viewing, such as of displays, associated with simulation results or outcomes, which can include use of a variety of graphical, visualization and analytical tools, among other things.

Step 1222 represents “One Click” advertising campaign-related action/implementation option(s), which may be made available to the advertiser in some embodiments of the invention. Various details are possibilities relating to this are discussed herein, including with regard to FIG. 8, among other places.

Some embodiments of the invention provide, for example, a system that enables an advertiser to self-serve, control, and perform computer advertising campaign simulations, such as by using, or modifying and using, an advertiser's ideal, high definition customer profile and an online/offline publisher's high definition audience segment profile. In some embodiments, methods are provided that enable an advertiser to define and create N number of high definition target customer profile templates, methods that enable an advertiser to select and or modify a publisher's high definition audience segment profile template from a library of such, and methods that enable the advertiser to select and or modify a matching program, such as a publisher's matching program, from a library of publisher's matching programs. Methods are provided that include analytics utilized, for example, to compute a match between an advertiser's high definition target customer profile to a publisher's high definition audience segment profile. Furthermore, methods are provided to execute scenario-based simulations, using, for example, techniques such as Monte Carlo simulations or other simulation techniques, in order to model and predict the outcome of N number of advertiser campaigns, for example. Moreover, in some embodiments, a system is provided that enables the advertiser to have an advertising campaign laboratory, to explore and experiment with different types of campaign options, and to test a variety of campaign possibilities and see the possible campaign results before spending any advertising campaign money. Techniques according to embodiments of the invention can increase an advertiser's revenue, such as by leading to better advertising campaign performance, such as higher conversion rates or increased advertising campaign return on investment. Techniques are provided that increase advertiser end-to-end advertising campaign control, and that reduce advertising campaign expenditures, such as on campaigns targeting the incorrect or non-optimized audiences.

One advertiser or Chief Marketing Officer ideal goal can be to create and test advertising campaign effectiveness before spending campaign dollars. Testing campaigns can help minimize the advertising campaign misalignment between customer profiles and target audience profiles, for example. Better alignment can increase an advertiser's revenue, increase advertising campaign return on investment, and reduces advertising campaign expenses on campaigns targeting the incorrect audiences, as the alignment gap decreases. Some embodiments of the invention provide a system that helps close the alignment gap between advertisers' ideal target customers and online/offline publishers' audiences, such as by executing models, simulating advertising campaigns, and allowing advertisers and publishers to gain projected end-result campaign insights before spending money.

Some embodiments provide an advertiser with a portal into all online and offline advertising channels and inventory. The advertiser can use this data as inputs to their campaign simulations models. This can help prevent marketers from wasting time creating campaign models and simulations with online and offline options that do not exist, for example.

Some embodiments include utilizing or providing advertisers with real prices. Advertisers can use this real data as inputs to their campaign simulation models. This can allow easier and faster modeling and simulating of pricing scenarios for an entire campaign, regardless of the number of online and offline advertising channels that support an overarching campaign simulation. As such, this can provide more realistic campaign cost estimates using real prices.

Some embodiments provide advertisers with the ability to create, templatize, store and retrieve global advertising campaign simulations, such as in a library of such. This can allow easier and faster creation of new and derivative scenarios, which can encourage marketeers to explore and experiment without spending money.

Some embodiments provide advertisers with the ability to integrate input variables or information from their own customer databases into their simulation templates, which can sharpen and focus advertising campaign simulations.

Some embodiments provide advertisers with the ability to incorporate input variables or information, such as from their advertising agencies, third party partners (e.g. Nielsen), and other value-chain third party service providers, into their simulation templates.

Some embodiments provide advertisers with the ability to incorporate algorithms and analytics into their simulation templates, which can include utilizing machine learning techniques to improve simulations.

Some embodiments provide an advertiser with the ability to look at a publisher's library of simulation templates to better view, control, and test advertising campaign simulations. This can help provide an advertiser with a variety of simulations to help the advertiser quickly learn how to use the system and to guide the advertiser with campaign simulations that are successful.

Some embodiments provide an advertiser with a search and recommendation engine to, for example, find simulation segments in the publisher's simulation segment library. This can include providing the advertiser with the ability to search and quickly identify the most relevant simulation models and methodologies.

Some embodiments include allowing an advertiser to create or modify publisher simulation templates, which can enable the advertiser to fine tune, optimize, and better align the advertiser's simulations.

Some embodiments enable an advertiser to launch N number of campaign simulations without having to know various math techniques and statistics. This can encourage marketeers of all levels of knowledge and experience to explore and experiment with campaign simulations, providing an easy tool for non-math users, while also providing a powerful tool for PhDs to built and incorporate their own simulation models or algorithms, for example.

Some embodiments enable publishers to create global/scalable simulations for all ecosystem players, increasing publisher revenue by providing a global advertising campaign simulation service.

Some embodiments enable a publisher to connect all of the online and offline advertisers to make it easier for advertisers to one-stop simulate advertising global campaigns. This can increase publisher revenue by making it easier and faster to “try before you buy”/“test drive”, and can further encourage marketeers spend every advertising campaign dollar in their budget.

Some embodiments enable publishers to create sophisticated, analytics-driven campaign simulation options for advertisers, which can include recommendation systems and services, and could incorporate social network, social network connections or social networking services or Web sites. For example, a recommendation can be provided such as, “People who created this campaign simulation also purchased this audience segment”. This can increase publisher revenue by providing new offers and next best offers, for example.

Some embodiments provide systems and methods using software, databases, and modern communication methods to enable advertisers and publishers to model advertising campaign simulations. Modeling may be performed by incorporating inputs, such as an advertiser's ideal, high definition target customer profile and a publisher's online/offline high definition audience segment profile, and then performing simulations, such as Monte Carlo simulations, on these data sets to project, determine and observe potential campaign results.

In some embodiments, methods are provided that that enable an advertisers to define and create N number of simulations stored in simulation profile templates. Methods are provided that that enable an advertiser to select, or modify and select, a publisher's simulation profile from a library of N simulation profiles. Furthermore, methods are provided that enable the advertiser to create and upload their own simulation programs, and to incorporate input data from third party service providers, for example.

In some embodiments, a system is provided that creates an advertising campaign laboratory. The lab, for example, can enable the marketeer to explore and experiment with different types of campaign options, to simulate a variety of campaign possibilities, and to examine possible campaign results, such as before spending any advertising campaign money.

In various embodiments, the system can be used as a standalone system or can be used with upstream systems or advertising campaign management subsystems, or with third party ecosystem service providers.

In some embodiments, a publisher can create sophisticated simulation templates, such as by industry, sub-industry, micro-industry, etc.

In some embodiments, an advertiser can significantly increase revenue and return on investment by simulating campaigns before actually buying campaigns that would turn out to be ineffective or low-performing.

Some embodiments allow advertisers and other parties to utilize and take advantage of granular information, while yet preserving a necessary degree of privacy and anonymity. For example, some embodiments enable advertisers to run simulations but not violate customer privacy and to avoid audience personal privacy information (PII) disclosure. For example, in some embodiments, advertiser customer data or publisher audience data, which the advertiser or the publisher may highly value as “crown jewels”, stays behind a corporate firewall, while derived information is nonetheless well-utilized.

Some embodiments provide a global system to accurately simulate global online and offline campaigns. Systems are provided that incorporate various ecosystem data sources when executing a campaign simulation, in order to accurately model and predict outcomes.

Some embodiments provide systems that address European Union PII issues, which have been significantly more rigid than Unites States PII governance. According to some embodiments, simulations do not store any information that uniquely identifies a customer.

In some embodiments, a simulation can have N number of simulation variables and algorithms to provide increasingly refined and more accurate campaign simulations. In some embodiments, machine learning techniques are incorporated, such to allow the system to learn over time, which can include using, for example, stored and updated algorithms from a library of such.

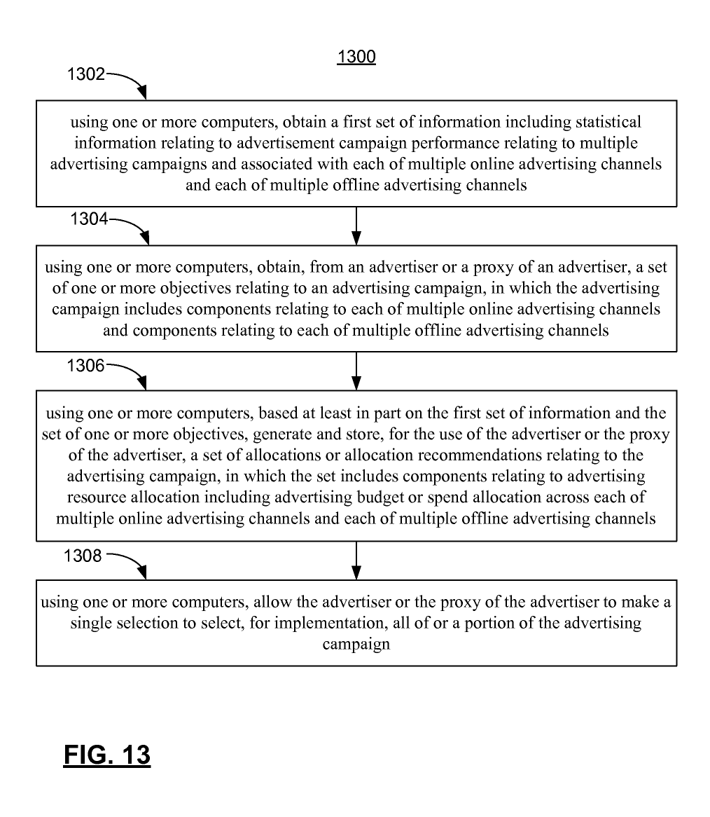

FIG. 13 is a flow diagram illustrating a method 1300 according to one embodiment of the invention. At step 1302, using one or more computers, a first set of information is obtained, including statistical information relating to advertisement campaign performance relating to multiple advertising campaigns and associated with each of multiple online advertising channels and each of multiple offline advertising channels.

At step 1304 using one or more computers, from an advertiser or a proxy of an advertiser, a set of one or more objectives relating to an advertising campaign is obtained, in which the advertising campaign includes components relating to each of multiple online advertising channels and components relating to each of multiple offline advertising channels.

At step 1306, using one or more computers, based at least in part on the first set of information and the set of one or more objectives, for the use of the advertiser or the proxy of the advertiser, a set of allocations or allocation recommendations relating to the advertising campaign are generated and stored. The set includes components relating to advertising resource allocation including advertising budget or spend allocation across each of multiple online advertising channels and each of multiple offline advertising channels.

At step 1308, using one or more computers, the advertiser or the proxy of the advertiser is allowed to make a single selection to select, for implementation, all of or a portion of the advertising campaign.

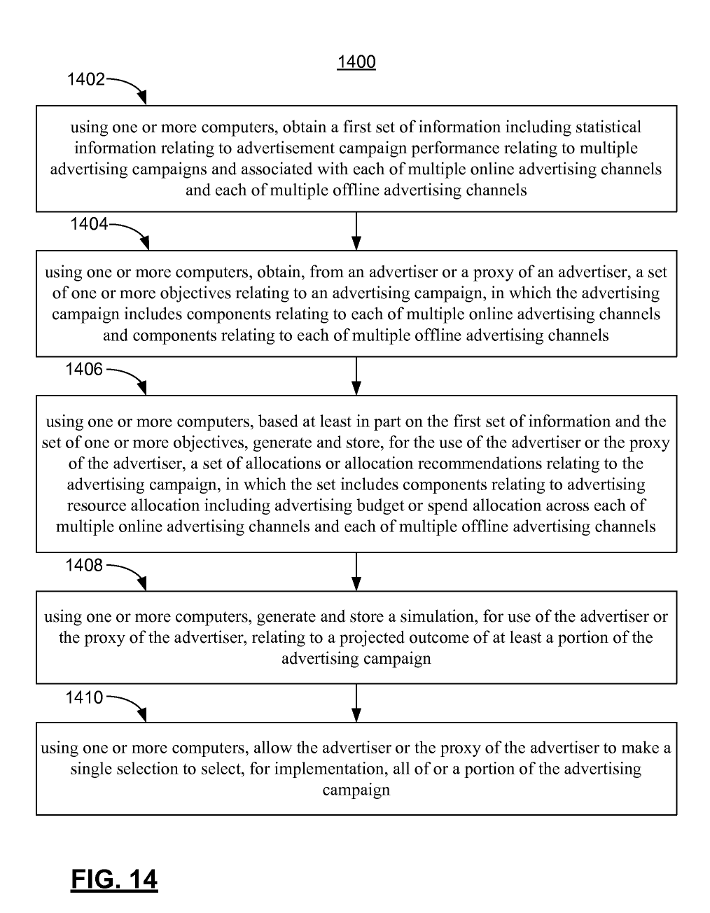

FIG. 14 is a flow diagram illustrating a method 1400 according to one embodiment of the invention. At step 1402, using one or more computers, a first set of information is obtained, including statistical information relating to advertisement campaign performance relating to multiple advertising campaigns and associated with each of multiple online advertising channels and each of multiple offline advertising channels.

At step 1404, using one or more computers, from an advertiser or a proxy of an advertiser, a set of one or more objectives is obtained relating to an advertising campaign, in which the advertising campaign includes components relating to each of multiple online advertising channels and components relating to each of multiple offline advertising channels.

At step 1406, using one or more computers, based at least in part on the first set of information and the set of one or more objectives, for the use of the advertiser or the proxy of the advertiser, a set of allocations or allocation recommendations relating to the advertising campaign are generated and stored. The set includes components relating to advertising resource allocation including advertising budget or spend allocation across each of multiple online advertising channels and each of multiple offline advertising channels.

At step 1408, using one or more computers, a simulation is generated and stored, for use of the advertiser or the proxy of the advertiser, relating to a projected outcome of at least a portion of the advertising campaign.

At step 1410, using one or more computers, the advertiser or the proxy of the advertiser is allowed to make a single selection to select, for implementation, all of or a portion of the advertising campaign.

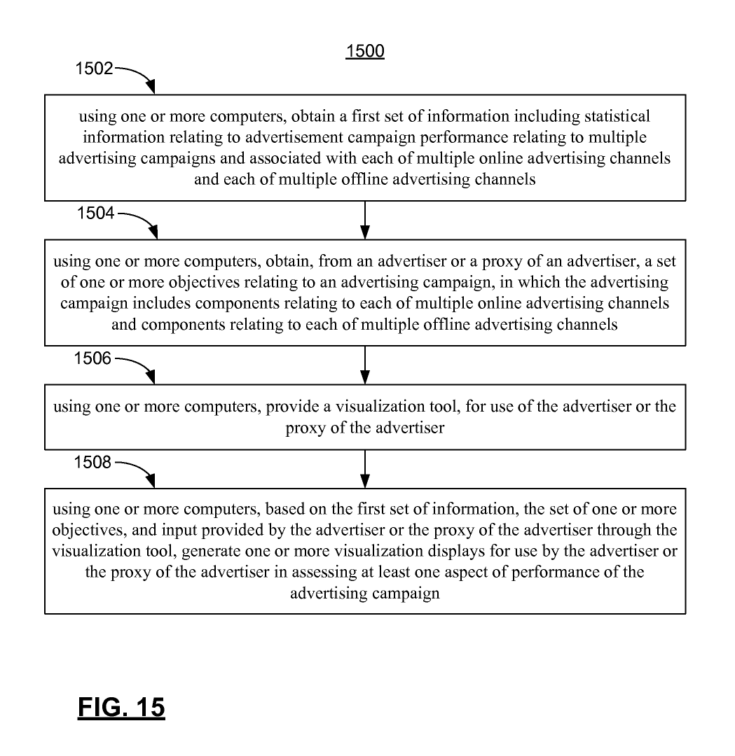

FIG. 15 is a flow diagram illustrating a method 1500 according to one embodiment of the invention. At step 1502, using one or more computers, a first set of information is obtained, including statistical information relating to advertisement campaign performance relating to multiple advertising campaigns and associated with each of multiple online advertising channels and each of multiple offline advertising channels.

At step 1504, using one or more computers, from an advertiser or a proxy of an advertiser, a set of one or more objectives IS obtained, relating to an advertising campaign, in which the advertising campaign includes components relating to each of multiple online advertising channels and components relating to each of multiple offline advertising channels.

At step 1506, using one or more computers, a visualization tool is provided, for use of the advertiser or the proxy of the advertiser.

At step 1508, using one or more computers, based on the first set of information, the set of one or more objectives, and input provided by the advertiser or the proxy of the advertiser through the visualization tool, one or more visualization displays are generated for use by the advertiser or the proxy of the advertiser in assessing at least one aspect of performance of the advertising campaign.

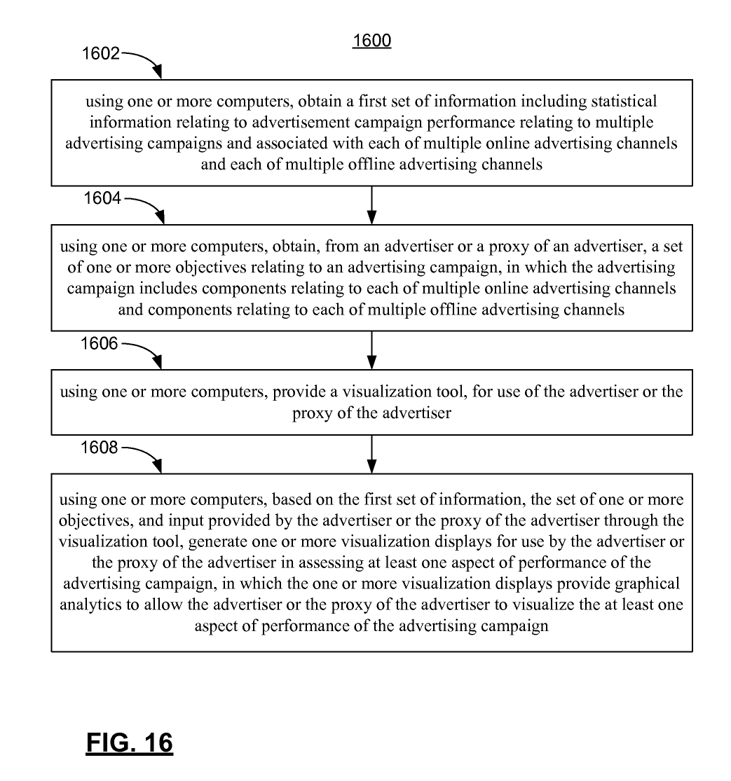

FIG. 16 is a flow diagram illustrating a method 1600 according to one embodiment of the invention. Steps 1602, 1604 and 1606 are similar to steps 1502, 1504 and 1506 as depicted in FIG. 5.

At step 1608, using one or more computers, based on the first set of information, the set of one or more objectives, and input provided by the advertiser or the proxy of the advertiser through the visualization tool, one or more visualization displays are generated for use by the advertiser or the proxy of the advertiser in assessing at least one aspect of performance of the advertising campaign. The one or more visualization displays provide graphical analytics to allow the advertiser or the proxy of the advertiser to visualize the at least one aspect of performance of the advertising campaign.

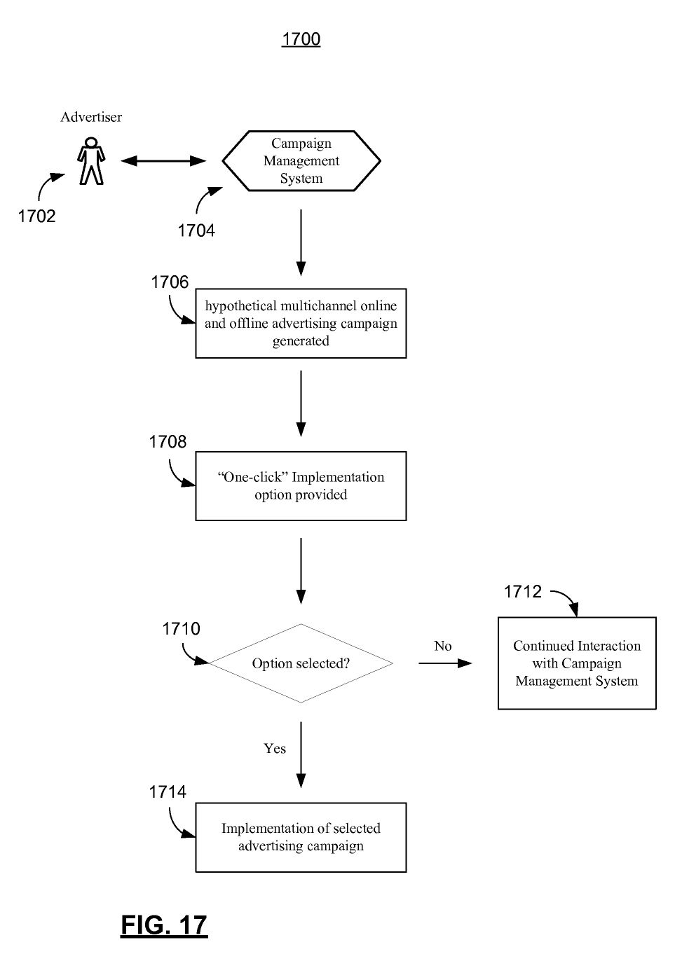

FIG. 17 is a block diagram illustrating one embodiment of the invention. An advertiser 1702 is depicted, interacting with a Campaign Management System 1704 according to one embodiment of the invention.

At block 1706, utilizing advertiser interaction with the Campaign Management System 1704, a hypothetical multichannel online and offline advertising campaign is generated.

At block 1708, the advertiser 1702 is provided with a “one-click” advertising campaign implementation option. This option may, for example, allow the advertiser 1702 to make a single selection (whether by click or any or other form of selection) to implement, cause to be implemented, or set or designate for implementation, the advertising campaign or a portion thereof.

At block 1710, the method 1700 queries whether the “one-click” implementation option has been selected. If not, then the method 1700 proceeds to block 1712, at which the advertiser 1702 may, for example, further interact with the Campaign Management System 1704 in any of various ways. If the “one-click” option is selected, then, at block 1714, the advertising campaign or a portion thereof is implemented, caused to be implemented, or set or designated for implementation.

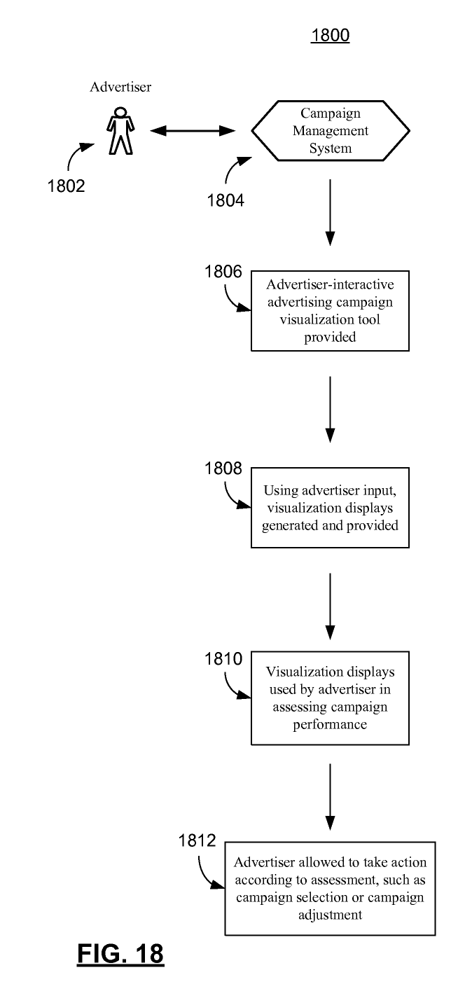

FIG. 18 is a block diagram illustrating one embodiment of the invention. An advertiser 1802 is depicted, interacting with a Campaign Management System 1804 according to one embodiment of the invention. At block 1806, an advertiser-interactive advertising campaign visualization tool is provided for the use of the advertiser 1802, such as in assessing one or more aspects of advertising campaign performance.

At block 1808, using advertiser input, visualization displays are generated and provided for the use of the advertiser 1802.

At block 1810, the visualization displays are used by the advertiser 1802 in assessing campaign performance.

At block 1812, the advertiser allowed to take action according to assessment, such as campaign selection or campaign adjustment.

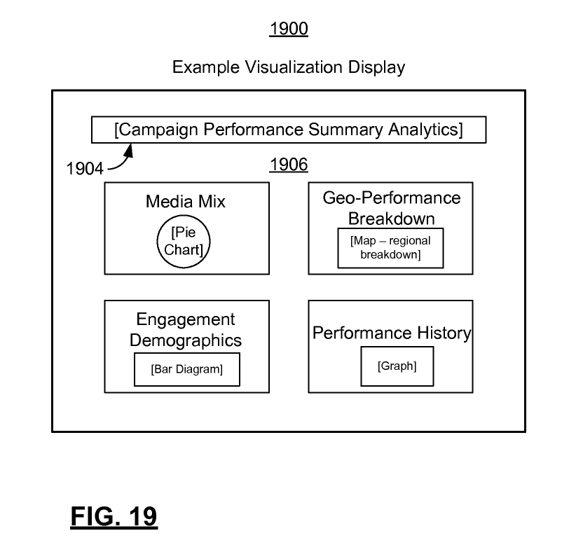

FIG. 19 is a block diagram 1900 illustrating one embodiment of the invention. Specifically, an example visualization display 1902 is depicted. For example, the visualization display 1902 may provide, with regard to a particular advertising campaign (whether hypothetical, simulated, actual, ongoing and partially complete, etc.), summary analytics 1904 (such as performance indicators, financials such as budget or spend, etc.) as well as a number of more granular information displays 1906. For example, the more granular information displays 1906 may relate to various aspects of the online and offline, multichannel campaign, and may provide numbers, graphs, etc. As depicted, the example displays 1906 include a media mix pie chart, which may display portions of the campaign dedicated to various media channels, for example. The example displays 1906 also include a geo-performance breakdown, which may include a display map with displayed regional performance information. The example displays 1906 also include an engagement demographics bar diagram, which may provide engagement performance information broken down by demographic segment or group. Furthermore, the example displays 1906 include a performance history graph, which may include segments indicating performance history over time for various aspects or channels of the campaign, for example.

Some embodiments of the invention provide techniques in which advertisers, with a single click or selection, can select, for implementation, all of or a portion of an advertising campaign.

In some embodiments, methods are provided that enable a marketeer to quickly and easily buy and launch an advertising campaign at the click of one button. In various embodiments, such methods can be used standalone or in conjunction with, for example, systems that portfolio manage all online and offline advertising information, from the advertiser and agency business perspectives, and methods including, for example, simulations, predictive and causal forecast modeling, actionable insight software engines, recommendation engines, data mining, visual analytics, text analytics, data warehouses, etc. This may allow optimization of overall business advertising goals, objectives, and models. Some embodiments recognize that marketers may need a faster way to buy and launch campaigns, which need may be in some ways analogous to the manner in which consumers have grown accustomed and demand “one click” checkout methods to purchase goods, for example.

In some embodiments, advertisers can use real data as inputs to their campaign simulations and models. In some embodiments, marketeers can avoid wasting time creating campaign models and simulations with online and offline options that do not exist, and can immediately one click purchase the campaign(s) for both online and offline ad campaigns, for example.

In some embodiments, advertisers are provided with the ability to create, templatize, store and retrieve global advertising campaign simulations and then one click purchase the campaign(s).

In some embodiments, advertisers are provided with various abilities, functionalities and options, which may culminate in an ability to simply and easily choose implementation of an advertising campaign or a portion of an advertising campaign, such as a generated, investigated, or assessed advertising campaign. Alternatively, an advertiser may choose such tools prior to utilizing a single selection to lead to modification, course-correction or adjustment of an existing and partially implemented campaign. Such tools and functionality can include, for example, visualization tools and displays, gathered performance analytics and third party data, templates, projections, simulations, campaign recommendation or suggestion engines, campaign-related search engines, prediction engines, modeling engines, campaign shopping cart functionality, etc.

Furthermore, in some embodiments, “one-click” techniques may be used in combination with advertising campaign laboratory tools. For example, such a lab may enable the marketeer to explore and experiment with different types of campaign options, to simulate a variety of campaign possibilities, and to examine possible campaign results before spending any advertisement campaign money. For example, once the advertiser decides to go forward with a particular campaign, a “one click” campaign can be executed, such as to purchase and launch the advertising campaign.

In some embodiments, “one-click” advertising campaign implementation can be used to further complement and extend the convenience, practicality, speed, comprehensiveness, and integrated experience of various aspects of embodiments of the invention.

Some embodiments of the invention provide a visualization tool to advertisers, through which visualization displays can be caused to be generated, which displays may provide, for example, visual analytics that can be used in assessing aspects of performance of an advertising campaign. For example, some embodiments provide methods that enable a marketeer to quickly and easily identify early campaign opportunities and trends by using analytically driven visualization data mining tools, predict or forecast campaign performance, analyze existing or partial campaign performance and trends, obtain granular, visual displays and graphics to assess and compare various campaign performance breakdowns, etc. Such methods can be used in a standalone fashion, or along with various other techniques according to embodiments of the invention.

Some embodiments provide advertisers with visualization tools to quickly visually see, operationalize, and take action on early advertising campaign opportunities and trends. This can, for example, help get campaigns to market sooner faster than competitors, or identify trends and opportunities faster than competitors.

In some embodiments, a visualization tool can provide, among other things, one or more applications, that can be viewed as, for example, allowing finding campaign-critical information that may easily otherwise be lost in a mountain of data. Competitors may be scrambling to launch advertising campaigns that are poor in terms of relevance or inefficient and losing money, while the advertiser using campaign visualization earns more revenue by using the right advertising channels and messages, and can visually see the results, for example.

In some embodiments, campaign visualization is provided that can help close the alignment gap between advertisers ideal target customer and online/offline publishers' target audience by transforming data into visualized information that is actionable. Such a visualization-enabled system may be surrounded by system generated insights, campaign recommendations, and actionable plans to help the marketeer take fast action, for example.

Some embodiments allow marketeers to visually see, in a picture (static or real-time) what advertising inventory is available and not waste time making phone calls, requests for proposals, bids, etc. to buy advertising inventory.

Some embodiments allow advertisers to more easily and more quickly visually compare prices visually and take actions when publisher advertising opportunities arise.

Some embodiments allow advertisers to visually see what campaigns, or portions thereof, are performing well or under-performing, and identify early campaign opportunities and recommendations before their competitors, thus gaining a material competitive advantage.

Some embodiments allow advertisers to globally visualize how campaigns are doing and to take macro and micro campaign-related actions quickly.

Some embodiments provide advertisers with an ability to operationalize campaigns faster than competitors by seeing data in the form of static or real-time visual images/videos rather than data and information, which may overwhelming and not actionable. This may provide various advantages, such as, for example, allowing the advertiser to spot early advertising opportunities based on inventory released or news, and operationalize associated campaigns faster than competitors. This can lead to increased return on investment for advertisers, with visualization of data leading to effective and fast campaign-related action or course-correction.

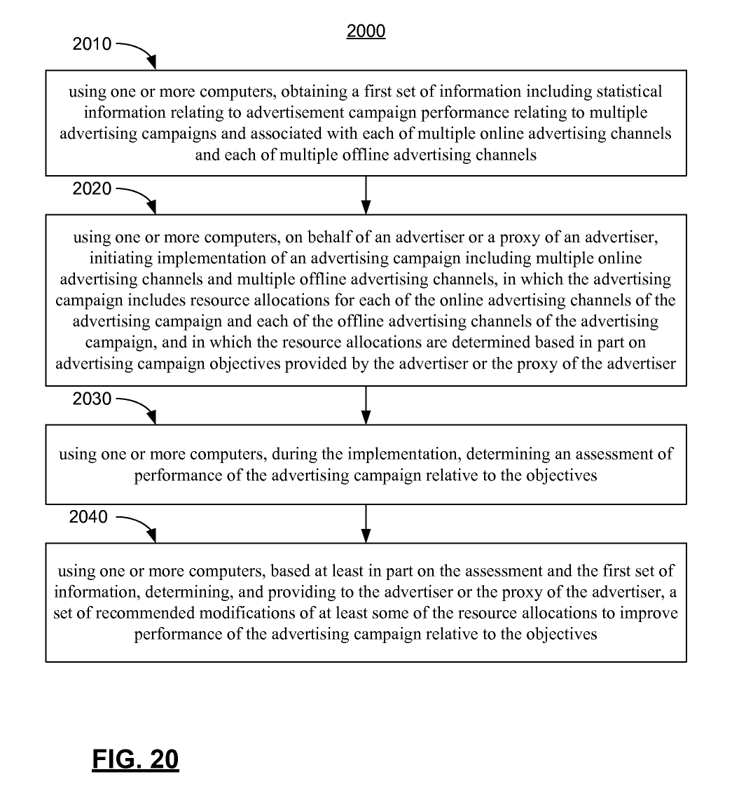

FIG. 20 is a flow diagram illustrating a method 2000 according to one embodiment of the invention.

At step 2010, the method 2000 includes, using one or more computers, obtaining a first set of information including statistical information relating to advertisement campaign performance relating to multiple advertising campaigns and associated with each of multiple online advertising channels and each of multiple offline advertising channels.

At step 2020, the method 2000 includes, using one or more computers, on behalf of an advertiser or a proxy of an advertiser, initiating implementation of an advertising campaign including multiple online advertising channels and multiple offline advertising channels, in which the advertising campaign includes resource allocations for each of the online advertising channels and each of the offline advertising channels, and in which the resource allocations are determined based in part on advertising campaign objectives provided by the advertiser or the proxy of the advertiser.

At step 2030, the method 2000 includes using one or more computers, during the implementation, determining an assessment of performance of the advertising campaign relative to the objectives.

At step 2040, the method 2000 includes using one or more computers, based at least in part on the assessment and the first set of information, determining, and providing to the advertiser or the proxy of the advertiser, a set of recommended modifications of at least some of the resource allocations to improve performance of the advertising campaign relative to the objectives.

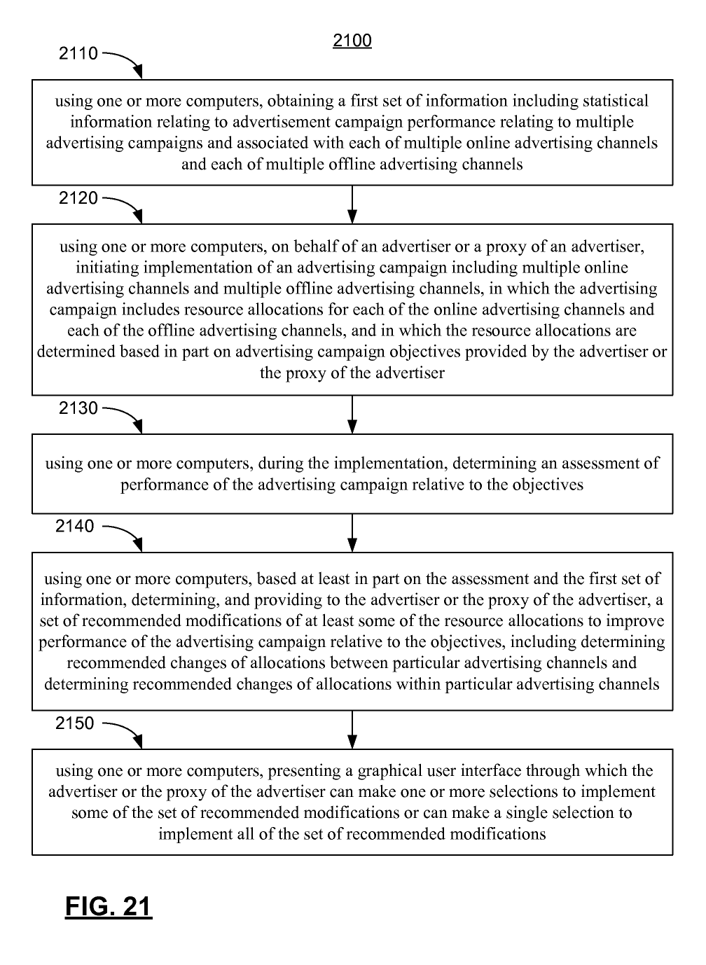

FIG. 21 is a block diagram illustrating a method 2100 according to one embodiment of the invention.

Steps 2110, 2120 and 2130 are similar to steps 2010 and 2020 of FIG. 20.

At step 2140, the method 2100 includes, using one or more computers, based at least in part on the assessment and the first set of information, determining, and providing to the advertiser or the proxy of the advertiser, a set of recommended modifications of at least some of the resource allocations to improve performance of the advertising campaign relative to the objectives, including determining recommended changes of allocations within particular advertising channels and determining recommended changes of allocations within particular advertising channels.

At step 2150, the method 2100 includes, using one or more computers, presenting a graphical user interface through which the advertiser or the proxy of the advertiser can select to implement some of the recommended modifications or can make a single selection to implement all of the set of recommended modifications. Modifications can include, among other things, for example, shifting of budget.

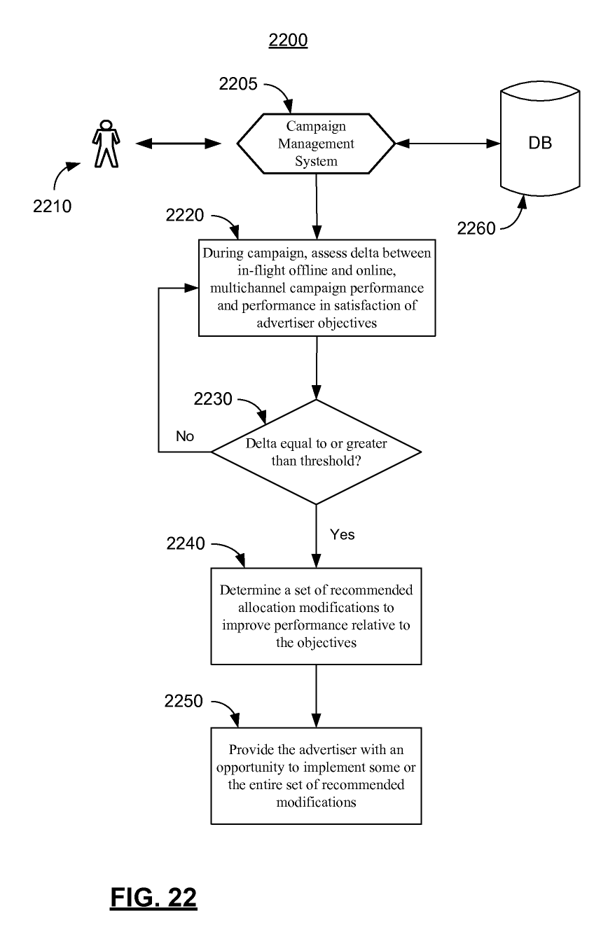

FIG. 22 is a block diagram 2200 illustrating one embodiment of the invention. An advertiser 2210 is depicted, interacting with a Campaign Management System 2205 according to one embodiment of the invention, which is coupled to one or more databases 2260. The database 2260 can contain many types of information, as described with regard to various embodiments. The database may include collected information relating to in-flight performance of an advertising campaign which has already been initiated, which can include performance information relating to a portion of the advertising campaign that has already occurred and for which performance information is available. Such in-flight campaign and campaign performance information can be utilized in assessing in-flight campaign performance, and can be useful in determining recommended modifications, such as modifications that may alter the course of a remaining portion of the campaign, relative to the course that would, might, or may be anticipated or projected to occur without such modifications, for example.

Block 2220 includes, during an in-flight, offline and online, multichannel advertising campaign, assessing a delta between performance of the campaign, to the extent such campaign has run and for which performance information is available, and performance in satisfaction of advertiser campaign objectives. This can include comparison of actual in-flight, partial campaign performance against ideal or hypothetical partial performance of a campaign in satisfaction of advertiser objective(s) (as one possible, simple example, 40% satisfaction of objectives after 40% run) or comparison of anticipated or projected entire actual campaign performance, based at least in part on in-flight, partial performance information, against ideal or hypothetical entire campaign performance in satisfaction of advertiser objectives, for example.

Block 2230 includes determining if a delta or difference is large enough to meet a certain threshold, which threshold may be advertiser-provided or determined or calculated based on any of a variety of parameters. The delta can be, for example, a difference between anticipated or desired campaign performance, to the point that the in-flight campaign has run and for which performance information is available, and actual assessed performance.

At block 2240, if the delta is less than the threshold, then the method 2200 proceeds back to block 2220, for example, after a period or certain amount of time has passed, such that the in-flight campaign will have run further or to a higher percentage of completion, for example.

At block 2240, if the delta is greater than the threshold, then the advertiser with an opportunity to implement some or the entire set of recommended modifications, such as through one or more applications or graphical user interfaces. This can include the advertiser choosing particular modifications, or making a selection or choice, such as a single click, to implement an entire set of recommended modifications. The modifications can include shifts or resources between channels, whether online or offline, such as from Internet to TV or radio, etc., or shifts of resources within particular channels, such as changing of bidded keywords or advertisements associated with an online campaign, changing spend between advertising associated with particular TV or radio channels, as just some examples.

Assessments and determination of recommended modifications can include use of information that was not available when the campaign was initiated, beyond in-flight campaign performance information, such as current events, trends, and other information.

Some embodiments of the invention provide methods and systems that enable an advertiser to self-serve, control, and automatically change online and offline campaigns that are currently running, or in-flight. The system may increase advertiser revenue by enabling the advertiser to optimize campaigns that are not performing as expected. Rather than wait for a campaign to complete and not achieve campaign objectives, the system may provide ongoing advertiser feedback in the event that a campaign is not performing against the advertiser's original metrics for success. Furthermore, the system may provide advertisers with alternative campaign recommendations to meet the intended campaign objective(s). Recommendations can execute manually or automatically based upon objectives or business rules established by each advertiser, for example. Such systems may be described as in-flight remap systems, which may in a sense remap an in-flight campaign in order to improve or optimize performance relative to advertiser objectives, for example.

In some embodiments, determined modifications are calculated and implemented automatically, without any needed advertiser interaction. The advertiser may be notified of such modifications, or may not be.

Some embodiments include a recognition that spending advertising dollars, from the advertiser executive perspective, is a difficult and challenging problem. Spending advertising dollars on the right campaign with the right content can still result in an ineffective or low ROI campaign if something unforeseen happens during a campaign that has already launched (e.g. natural disaster, geopolitical situation, corporate disaster, sentiment changes, “new” hot product announcement, competitor announcement, etc.). Such situations could lead to an ineffective campaign due to audience interest changing, for example. Some embodiments optimize already launched campaigns, by executing or enabling execution of in flight campaign changes that lead to overall increased advertiser revenue, for example.

Some embodiments including making insightful and timely campaign changes prior to campaign completion, which may increase revenue and ROI by remapping campaigns away from low or poor performing campaigns. Timely and relevant campaign changes may be made based upon remap campaign suggestions that take into account advertiser's campaign goals, objectives, budget, environment, news, and other information and developments.

Some embodiments provide a real time system that evaluates the actual performance of a campaign against the advertisers' campaign objective(s), goal(s), metric(s) for success, etc. and that provides recommendations and a means to change a currently ineffective/low poor performing campaign.

Some embodiments include a broad collection of methods and subsystems using hardware, software, databases, and modern communication methods that accomplish a number of tasks or objectives. Some embodiments compare an advertiser's actual campaign results against target goals, objectives, metrics for success, for example. In some embodiments, if the delta between actual results, such as partial or available results, and intended campaign goals is greater, in a negative way, than the threshold established in the advertiser-defined objectives or business rules (which may be defined by the advertiser in or using an objectives or business rules engine, for example), then the system begins exploring alternative campaigns that could achieve or better achieve the advertiser's intended campaign goals, objectives, metrics.

In some embodiments, if the system identifies such alternative campaigns, then the system sends a message to the advertiser, such as to review the currently running campaign, identifies issues with the current campaign meeting original objectives, and provides recommended, alternative campaigns that could better meet objectives.

In some embodiments, the advertiser may then review one or more recommended modifications, or one or more alternative campaigns, and can leave campaign as is, or can execute one or more of the recommended alternative system generated campaigns, for example.

In some embodiments, alternatively or additionally, the advertiser can set up an objectives or business rules engine to automatically execute one or more of the recommended alternative system-generated modification(s) or campaign(s) based on business criteria or objectives established by the advertiser.

In some embodiments, the objectives or business rules system and engine can perform a variety of tasks including, but not limited to, checking alternative campaign inventory, booking open alternative inventory, performing advertiser budget transaction transfers, integrating to other third party systems to support in-flight campaign changes, and others

In some embodiments, the objectives or business rules system can incorporate an analytics engine that evaluates and makes advertising campaign recommendations, such as without need for advertiser involvement. In some embodiments, the overall system, or the objectives or business rules system, can incorporate, implement or perform campaign changes. This may be advantageous, for example, in situations where a campaign needs only “fine tuning” as opposed to making a larger or material change, such as, for example, may be defined to include displaying an ad in a completely new category. In some embodiments, small changes may be implemented without advertiser authorization or interaction, whereas larger changes may require advertiser authorization or interaction.

In some embodiments, techniques are provided that enable advertisers to take immediate campaign action as campaigns are running and that are not delivering results as expected. This can allow delivery of optimization over the life of a campaign, which can, for example, increase overall revenue or campaign effectiveness.

In some embodiments, publishers and content providers can sell premium “optimized campaign” service levels, increasing revenue and differentiating themselves from competitors.

Some embodiments allow reduction of the time it takes for publishers and content providers to gain insights and consequently provide premium information services which command premium incremental revenue streams, helping allow high-speed intelligent campaigns.

While the invention is described with reference to the above drawings, the drawings are intended to be illustrative, and the invention contemplates other embodiments within the spirit of the invention.

1. A method comprising:
using one or more computers, obtaining a first set of information comprising statistical information relating to advertisement campaign performance relating to multiple advertising campaigns and associated with each of multiple online advertising channels and each of multiple offline advertising channels;
using one or more computers, on behalf of an advertiser or a proxy of an advertiser, initiating implementation of an advertising campaign including multiple online advertising channels and multiple offline advertising channels, wherein the advertising campaign includes resource allocations for each of the online advertising channels of the advertising campaign and each of the offline advertising channels of the advertising campaign, and wherein the resource allocations are determined based in part on advertising campaign objectives provided by the advertiser or the proxy of the advertiser;
using one or more computers, during the implementation, determining an assessment of performance of the advertising campaign relative to the objectives; and
using one or more computers, based at least in part on the assessment and the first set of information, determining, and providing to the advertiser or the proxy of the advertiser, a set of recommended modifications of at least some of the resource allocations to improve performance of the advertising campaign relative to the objectives.

2. The method of claim 1, wherein determining the recommended modifications comprises determining recommended changes between advertising channels.

3. The method of claim 1, wherein determining the recommended modifications comprises determining recommended changes of allocations within particular advertising channels.

4. The method of claim 1, wherein determining the recommended modifications comprises determining recommended modifications to optimize performance of the advertising campaign relative to the objectives.

5. The method of claim 1, wherein initiating implementation comprises implementing a portion of the advertising campaign.

6. The method of claim 1, comprising determining the assessment after partial completion of the advertising campaign, and wherein determining the recommended modifications comprises comparing actual performance of the partially complete advertising campaign against hypothetical performance of a partially complete advertising campaign in satisfaction of the objectives.

7. The method of claim 1, comprising presenting a graphical user interface through which the advertiser or the proxy of the advertiser can choose or select implementation of at least some of the recommended modifications.

8. The method of claim 1, comprising presenting a graphical user interface through which the advertiser or the proxy of the advertiser can make a single choice or selection to implement the entire set of recommended modifications.

9. The method of claim 1, comprising presenting to display to the advertiser or the proxy of the advertiser including a graphical display of anticipated performance of the advertising campaign to completion without the recommended modifications compared with anticipated performance of the advertising campaign to completion with the recommended modifications.

10. The method of claim 1, comprising presenting the advertiser or the proxy of the advertiser with multiple alternative sets of recommendations for campaign modifications.

11. The method of claim 1, comprising utilizing one or more machine learning techniques in making the assessment.

12. A system comprising:
one or more server computers coupled to a network; and
one or more databases coupled to the one or more server computers;
wherein the one or more server computers are for:
obtaining a first set of information comprising statistical information relating to advertisement campaign performance relating to multiple advertising campaigns and associated with each of multiple online advertising channels and each of multiple offline advertising channels;
on behalf of an advertiser or a proxy of an advertiser, initiating implementation of an advertising campaign including multiple online advertising channels and multiple offline advertising channels, wherein the advertising campaign includes resource allocations for each of the online advertising channels of the advertising campaign and each of the offline advertising channels of the advertising campaign, and wherein the resource allocations are determined based in part on advertising campaign objectives provided by the advertiser or the proxy of the advertiser;
during the implementation, determining an assessment of performance of the advertising campaign relative to the objectives; and
based at least in part on the assessment and the first set of information, determining, and providing to the advertiser or the proxy of the advertiser, a set of recommended modifications of at least some of the resource allocations to improve performance of the advertising campaign relative to the objectives.

13. The system of claim 12, wherein at least one of the one or more server computers are coupled to the Internet.

14. The system of claim 12, wherein determining the recommended modifications comprises determining recommended changes between advertising channels.

15. The system of claim 12, wherein determining the recommended modifications comprises determining recommended changes of allocations within particular advertising channels.

16. The system of claim 12, wherein determining the recommended modifications comprises determining recommended modifications to optimize performance of the advertising campaign relative to the objectives.

17. The system of claim 12, wherein initiating implementation comprises implementing a portion of the advertising campaign.

18. The system of claim 12, wherein determining the recommended modifications comprises determining the recommended modifications to improve performance of the advertising campaign relative to an anticipated performance in satisfaction of the objectives.

19. The method of claim 12, comprising presenting a graphical user interface through which the advertiser or the proxy of the advertiser can choose or select implementation of at least some of the recommended modifications.

20. A computer readable medium or media containing instructions for executing a method comprising:
using one or more computers, obtaining a first set of information comprising statistical information relating to advertisement campaign performance relating to multiple advertising campaigns and associated with each of multiple online advertising channels and each of multiple offline advertising channels;
using one or more computers, on behalf of an advertiser or a proxy of an advertiser, initiating implementation of an advertising campaign including multiple online advertising channels and multiple offline advertising channels, wherein the advertising campaign includes resource allocations for each of the online advertising channels of the advertising campaign and each of the offline advertising channels of the advertising campaign, and wherein the resource allocations are determined based in part on advertising campaign objectives provided by the advertiser or the proxy of the advertiser;
using one or more computers, during the implementation, determining an assessment of performance of the advertising campaign relative to the objectives; and
using one or more computers, based at least in part on the assessment and the first set of information, determining, and providing to the advertiser or the proxy of the advertiser, a set of recommended modifications of at least some of the resource allocations to improve performance of the advertising campaign relative to the objectives, comprising determining recommended changes of allocations within particular advertising channels and determining recommended changes of allocations within particular advertising channels; and
using one or more computers, presenting a graphical user interface through which the advertiser or the proxy of the advertiser can make one or more selections to implement some of the set of recommended modifications or can make a single selection to implement all of the set of recommended modifications.
